(19) United States
(12) Patent Application Publication
(10) Pub. No.: US 2013/0117093 A1
(43) Pub. Date: May 9, 2013

(54) METHOD AND SYSTEM TO DISCHARGE A LIABILITY ASSOCIATED WITH A PROPRIETARY CURRENCY

(71) Applicants: Lisa Maureen Oda, San Carlos, CA (US); Todd Kurie, Palo Alto, CA (US)

(72) Inventors: Lisa Maureen Oda, San Carlos, CA (US); Todd Kurie, Palo Alto, CA (US)

(73) Assignee: eBay Inc., San Jose, CA (US)

(21) Appl. No.: 13/565,606

(22) Filed: Aug. 2, 2012

Related U.S. Application Data
(63) Continuation of application No. 10/407,756, filed on Apr. 4, 2003.

(51) Int. Cl. G06Q 30/02

(52) U.S. Cl. CPC G06Q 30/0233
USPC 705/14.33

(57) ABSTRACT

A method and an apparatus to discharge a liability owed to a buyer and stored in a first proprietary currency. The apparatus receives authorization from the buyer to tender the first proprietary currency to pay for an offering that is listed by a seller on a network-based marketplace. The apparatus transmits a national currency to the seller who receives the national currency as payment for the offering. The transmission at least partially discharges the liability owed to the buyer.

### CROSS-REFERENCE TO RELATED APPLICATIONS

This application is a continuation of U.S. application Ser. No. 10/407,756, filed Apr. 4, 2003; which application is incorporated in its entirety herein by reference.

### FIELD OF THE INVENTION

The present invention relates generally to the field of online promotions and, more specifically to discharging a liability associated with a proprietary currency.

### BACKGROUND OF THE INVENTION

A number of businesses offer incentive points and other proprietary currency to their customers to promote the sale of goods and/or services. For instance, many airlines offer travel miles to encourage customers to purchase airline tickets. The incentive points represent a liability to the business because the business must redeem the incentive points by rewarding the customer,

Businesses face challenges with respect to incentive points that have been issued to customers but not yet redeemed. Sometimes the customer is not interested in the rewards offered by the business, Other times the business would like to decrease the amount of associated liability for financial reasons. Some businesses have solved these problems by redeeming incentive points for cash. This solution may satisfy the customer with a broader range of choice and may reduce liability owed by the business; however, it fails to capitalize on the captured buying power that is stored in the incentive points (e.g., the holder of the points is limited to the provided means of redemption).

### SUMMARY OF THE INVENTION

A method to discharge a liability owed to a buyer and stored in a first proprietary currency, the method including receiving authorization from the buyer to tender the first proprietary currency to pay for an offering that is listed by a seller on a network-based marketplace and transmitting a national currency to the seller, the seller receiving the national currency as payment for the offering, the transmission to at least partially discharge the liability owed to the buyer.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating a system to discharge a liability owed to a buyer and stored in a first proprietary currency, according to an exemplary embodiment of the present invention;

FIG. 2 is a block diagram illustrating software and hardware components of the network-based marketplace machine, the client machine, and the partner machine, according to an exemplary embodiment of the present invention;

FIG. 3 is a block diagram illustrating hardware components of the payment machine utilized by the system, according to an exemplary embodiment of the present invention;

FIG. 4 is a block diagram illustrating hardware components of the promotion machine utilized by the system, according to an exemplary embodiment of the present invention;

FIG. 5 is a block diagram illustrating an exemplary secondary conversion module;

FIG. 6 is a block diagram illustrating an exemplary primary conversion module an exemplary authorization module;

FIG. 7 is a block diagram illustrating an exemplary merchandise module;

FIG. 8 is a database diagram illustrating an exemplary database maintained and accessed via a database engine server that supports the network-based marketplace machine;

FIG. 9 is a database diagram illustrating various fields from the user table the purchase history table and the listing table as embodied on the database at the network-based marketplace machine;

FIG. 10 is a database diagram illustrating an exemplary database maintained and accessed via a database engine server that supports the payment machine;

FIG. 11 is a database diagram illustrating an exemplary database maintained and accessed via a database engine server that supports the promotion machine;

FIG. 12 is an interactive flow chart illustrating a method, according to an exemplary embodiment of the present invention, to convert at least one second proprietary currency to a first proprietary currency;

FIG. 13 is an interactive flowchart illustrating a method, according to an exemplary embodiment of the present invention, to discharge a liability owed to a buyer and stored in a primary proprietary currency;

FIG. 14 is a flowchart illustrating a method, according to an exemplary embodiment of the present invention, to merchandise offerings to a buyer based on the quantity of primary proprietary currency owned by the buyer and the marketing history of the buyer;

FIGS. 15-27 illustrate user interface screens, according to an exemplary embodiment of the present invention;

FIG. 28 illustrates a diagrammatic representation of machine in the exemplary form of a computer system within which a set of instructions, for causing the machine to perform any one or more of the methodologies discussed herein, may be executed.

### DETAILED DESCRIPTION

A method and system to discharge a liability associated with a proprietary currency, are described, In the following description, for purposes of explanation, numerous specific details are set forth in order to provide a thorough understanding of the present invention. It will be evident, however, to one skilled in the art that the present invention may be practiced without these specific details.

In general, embodiments described below feature an incentive engine that allows a buyer to pay for products or services on a network-based marketplace with proprietary currency. Proprietary currency is a currency that is issued by the network based marketplace and may take the form of incentive points, coupons, gift certificates, rebates. etc. The incentive engine receives authorization from the buyer to tender a primary proprietary currency to a seller as payment for purchasing a listed product or service on the network-based marketplace. In response, the incentive engine pays the seller with a national currency (e.g., USD, Francs, Pounds) of equal value.

The incentive engine registers primary proprietary currency to a buyer in response to the buyer entering a redemption code associated with the primary proprietary currency or in response to the buyer requesting conversion of secondary proprietary currency into primary proprietary currency. Secondary proprietary currency is issued by an entity other than the network-based marketplace and may not be tendered as payment to a seller on the network-based marketplace.

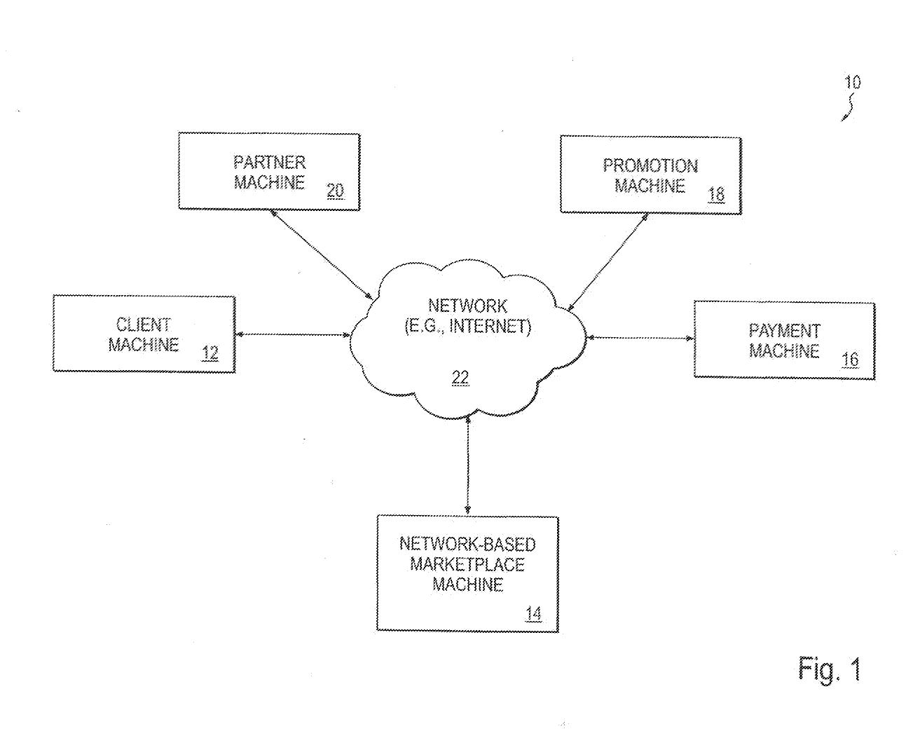

FIG. 1 is a block diagram illustrating a system 10 to discharge a liability owed to a buyer and stored in a primary or first proprietary currency, according to an exemplary embodiment of the present invention. The system 10 includes a client machine 12, a network-based marketplace machine 14, a payment machine 16, a promotion machine 18, and a partner machine 20 that communicate via a network 22. The network 22 may be embodied as Internet, a LAN, a WAN, PSTN, Frame Relay, ATM, satellite communications, wireless communications, combinations thereof, or any other network equipment or protocol that enables electronic communication between the above described network entities.

The client machine 12 enables the client to access services that are provided by the network-based marketplace machine 14, the payment machine 16, the promotion machine 18 and the partner machine 20.

The network-based marketplace machine 14 provides online marketplace services that enable sellers and buyers to transact items and services. A buyer that submits a winning bid in an auction or executes a purchase to complete a sale may acquire goods and/or services from the seller.

The network-based marketplace machine 14 may also issue primary proprietary currency in the form of coupons, gift certificates, rebates, etc. to incentivize buyers, sellers or partners of the network-based marketplace to take certain actions e.g., promotions). In addition, the primary proprietary currency may also be traded after it has been issued. For example the network-based marketplace, partners of the network and buyers and sellers of the network-based marketplace may each offer and acquire primary proprietary currency.

In one embodiment the network-based marketplace machine 14 may be embodied as “eBay The World's Online Marketplace”™ created by Ebay of San Jose, Calif.

The payment machine 16 provides payment services that enable a user that utilizes e-mail electronically to send and receive payments over the network 22. The payment machine 16 includes the incentive engine that registers, stores and redeems proprietary currency. For example, the payment machine 16 may be embodied as the Paypal™ Payment Service operated by PayPal of San Jose, Calif.

The partner machine 20 virtually issues secondary proprietary currency to a buyer usually to incentivize the buyer to purchase goods and/or services offered by the partner. For example, Hilton Hotels Corporation of Beverly Hills, Calif. hosts a web site that virtually issues “Hilton Honors Points and Miles” to encourage their guests to consistently return to Hilton Hotels.

The promotion machine 18 supports the partner machine 20 by providing underlying processing necessary for the partner machine 20 to virtually issue the secondary proprietary currency to buyers. Further, in response to a request from the buyer, the promotion machine 18 will convert the secondary proprietary currency to a primary currency and communicate the secondary currency to the payment machine 16.

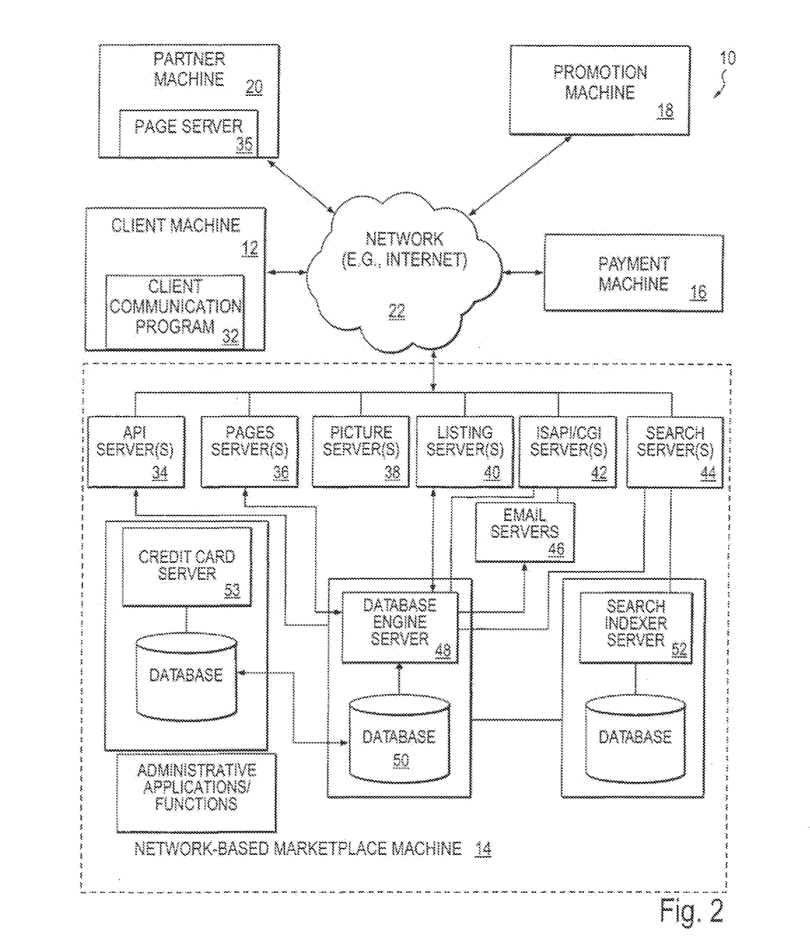

FIG. 2 is a block diagram illustrating software and hardware components of the network-based marketplace machine 14, the client machine 12, and the partner machine 20, according to an exemplary embodiment of the present invention.

In addition to other software components that are not illustrated, the client machine 12 includes a client communication program 32. The client communication program 32 enables a user to display web pages or e-mail that are loaded from server computers. The client communication program 32 may be embodied as a browser (e.g., the Microsoft Internet Explorer browser developed by Microsoft™ Corporation of Richmond, Wash. or Navigator™ browser developed by Netscape of Mountain View, Calif.). The client communication program 32 executes under an operating system (e.g., Microsoft™ Windows developed by Microsoft™ Corporation or Mac OS X developed by Apple Computers of Cupertino, California). The client communication program 32 may also be embodied as a mail client (e.g., the Microsoft Outlook personal information manager developed by Microsoft™ Corporation of Richmond, Wash. or Lotus Notes™ developed by the Lotus Notes Development Corporation.

In addition to other software components that are not illustrated, the partner machine 20 includes a page server 35. The page server 35 delivers web pages (e.g., mark-up language documents) that enable a user to access the promotional services that are provided by the promotion machine 18.

The network-based marketplace machine 14 includes one or more of a number of types of front-end servers, namely communications servers in the exemplary form of an application program interface (API) servers 34, page servers 36 that deliver web pages (e.g., markup language documents), picture servers 38 that dynamically deliver images to be displayed within Web pages, listing servers 40, processing servers in the exemplary form of CGI (or ISAPI) servers 42 that provide an intelligent interface to back-end servers, and search servers 44 that handle search requests to the network-based marketplace machine 14. The e-mail servers 46 provide, inter alia, automated e-mail communications to users of the network-based marketplace machine 14.

The back-end servers include a database engine server 48, a search index server 24 and a credit card database server 26, each of which maintains and facilitates access to a respective database.

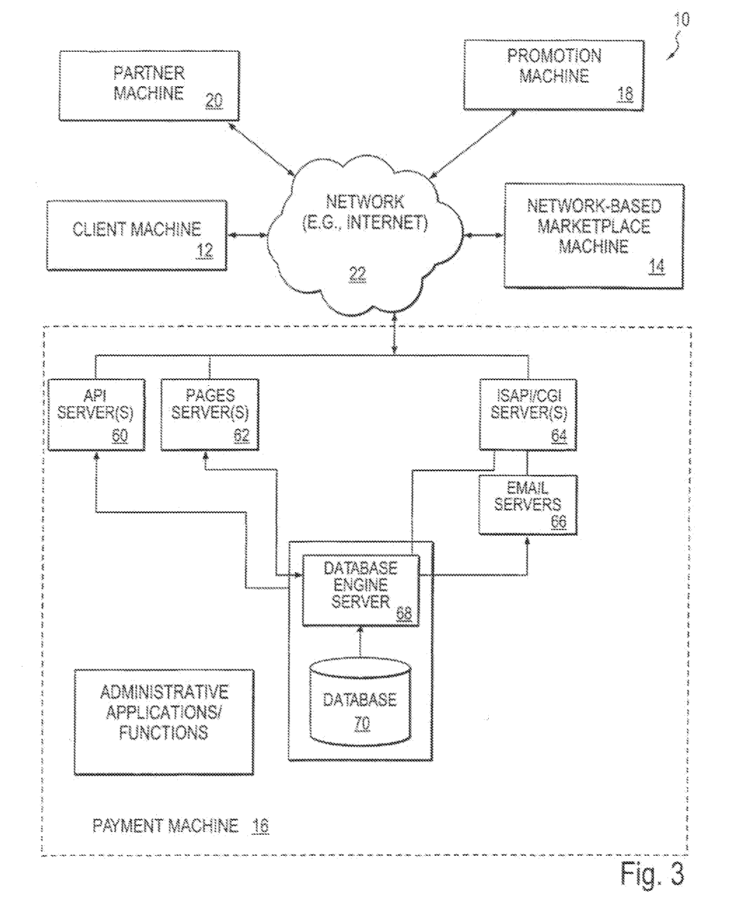

FIG. 3 is a block diagram illustrating hardware components of the payment machine 16 utilized by the system 10, according to an exemplary embodiment of the present invention.

The payment machine 16 includes one or more of a number of types of front-end servers, namely communications servers in the exemplary form of an application program interface (API) servers 60, page servers 62 that deliver web pages (e.g., markup language documents), processing servers in the exemplary form of CGI (or ISAPI) servers 64 that provide an intelligent interface to back-end servers. The e-mail servers 66 provide, inter alia, automated e-mail communications to users of the payment machine 16. The back-end servers include database engine servers 68 that maintains and facilitates access to a a database 70.

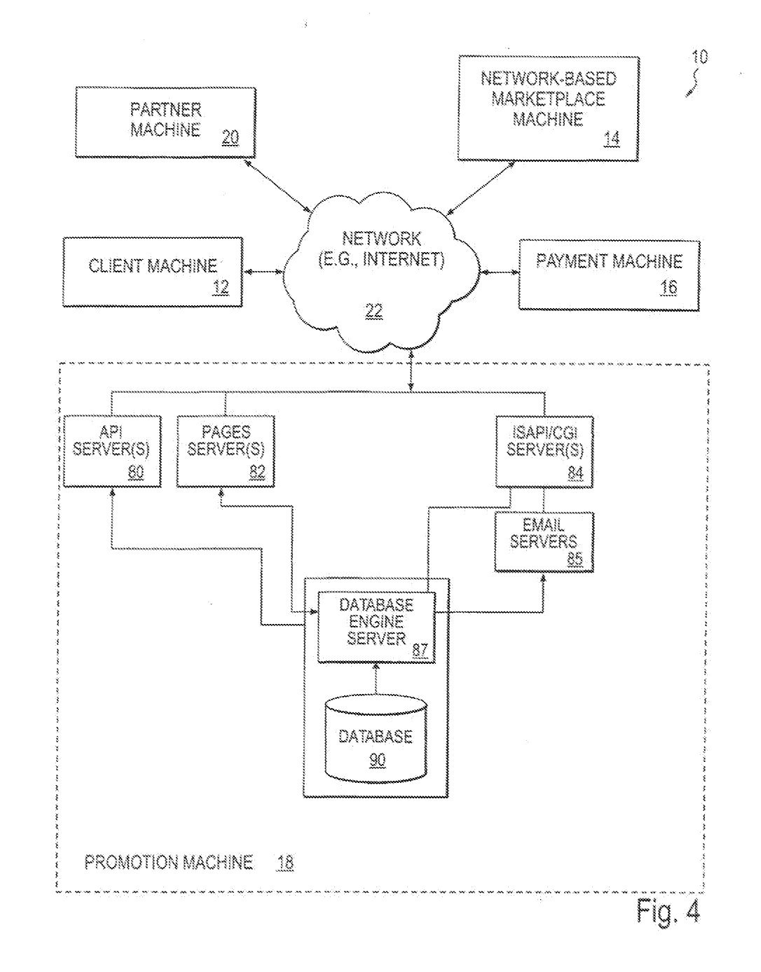

FIG. 4 is a block diagram illustrating hardware components of the promotion machine 18 utilized by the system 10, according to an exemplary embodiment of the present invention.

The promotion machine 18 includes one or more of a number of types of front-end servers, namely communications servers in the exemplary form of an application program interface (API) servers 80, page servers 82 that deliver web pages (e.g., markup language documents), processing servers in the exemplary form of CGI (or NAPO servers 84 that provide an intelligent interface to back-end servers. The e-mail servers 85 provide, inter alia, automated e-mail communications to users of the promotion machine 18. The back-end servers include a database engine server 87 that maintains and facilitates access to a database 90.

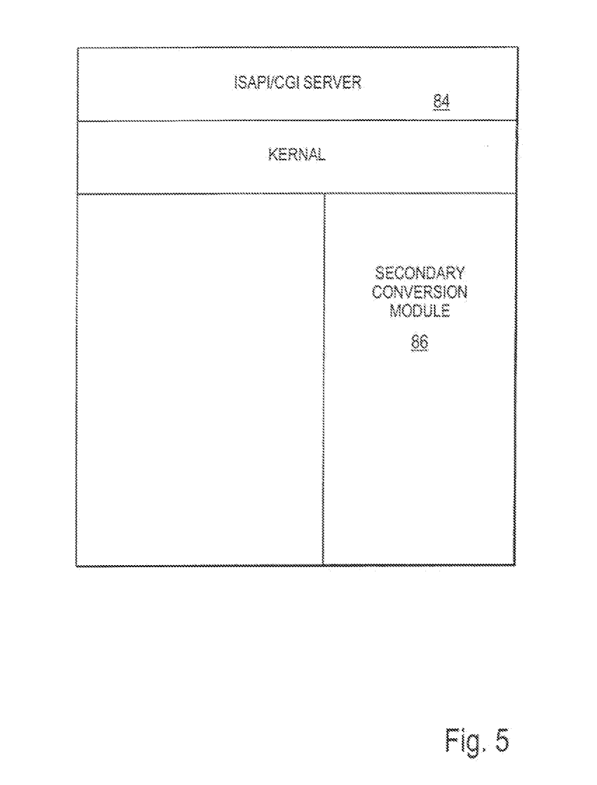

FIG. 5 is a block diagram illustrating an exemplary secondary conversion module 86. The secondary conversion module 86 executes on the ISAPI/CGI server 84 on the promotion machine 18 and under kernel operating software to convert a secondary or second proprietary currency in the exemplary form of ABC Honors Points to a primary or first proprietary currency in the exemplary form of XYZ Anything Points. The secondary conversion module 86 also communicates the XYZ Anything Points to an account associated with the buyer on the payment machine 16.

In addition, the secondary conversion module 86 computes a charge for issuing the XYZ Anything Points to the buyer. The secondary conversion module 86 credits and debits associated points and cash accounts for the respective parties (e.g., buyer, network-based marketplace, partner).

Further, the secondary conversion module 86 may perform the above operations in reverse thereby converting XYZ Anything Points to ABC Honors Points. In alternate embodiments the secondary conversion module 86 may operate under the incentive engine 89 on the ISAPI/CGI server 64 on the payment machine 16 or on the ISAPI/CGI server 42 on the network-based marketplace machine 14.

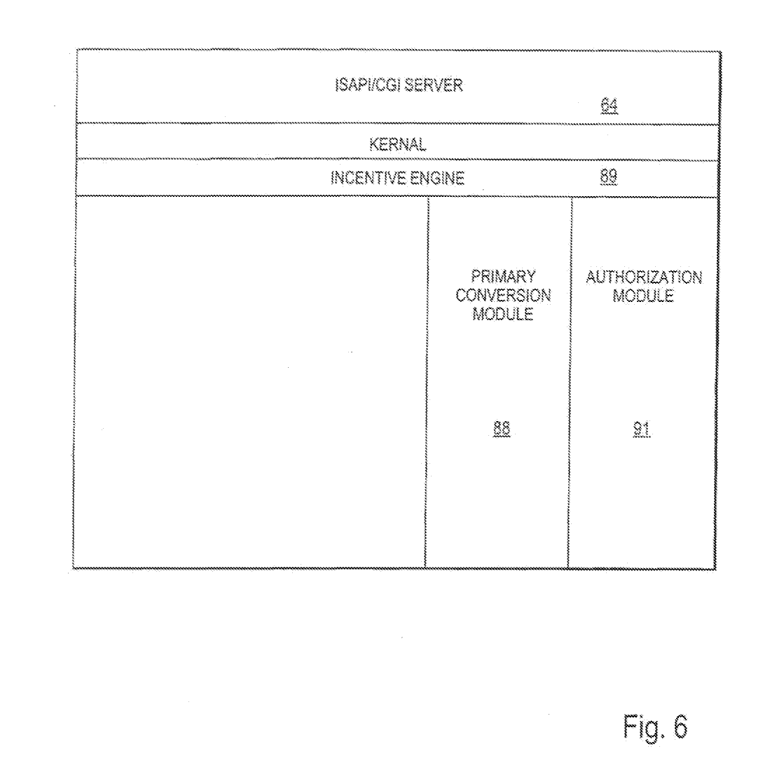

FIG. 6 is a block diagram illustrating an exemplary primary conversion module 88 and exemplary authorization module 91. The primary conversion module 88 and the authorization module 91 execute on the ISAPI/CGI server 64 and under kernel operating software under an incentive engine 89 on the payment machine 16.

The primary conversion module 88 is utilized to convert primary proprietary currency , promotion points including XYZ Anything Points, coupons, rebates, gift certificates) to a national currency. The (primary conversion module 88 credits and debits associated points and cash accounts for the respective parties buyer, seller, network-based marketplace). The (primary conversion module 88 will not convert secondary proprietary currency to national currency.

The authorization module 91 receives authorization from a buyer to tender a first proprietary currency to pay for an offer listed by a seller on a network-based marketplace. The authorization module 91 communicates the authorization from the buyer to the primary conversion module 88. Further, the authorization module 91 may cause a proprietary currency coupon, rebate or gift certificate to expire after a predetermined period of time. In alternate embodiments, the authorization module 91 and the primary conversion module 88 may operate on ISAPI/CGI server 42 on the network-based marketplace machine 14.

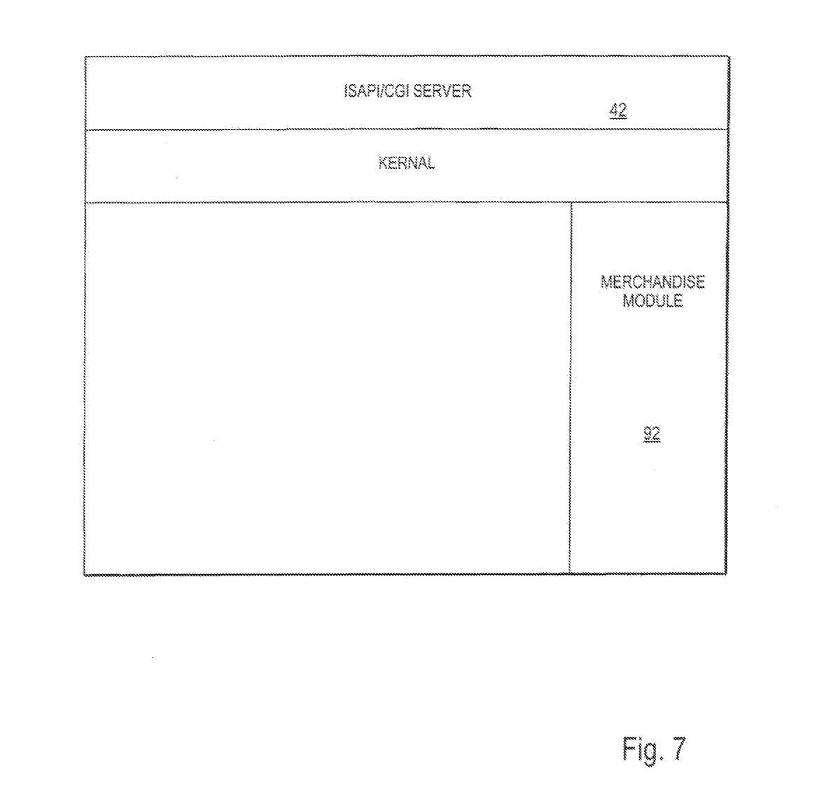

FIG. 7 is a block diagram illustrating an exemplary merchandise module 92. The merchandise module 92 executes on the ISAPI/CGI server 42 on the network-based marketplace machine 14 and under kernel operating software to merchandise an offering to a buyer.

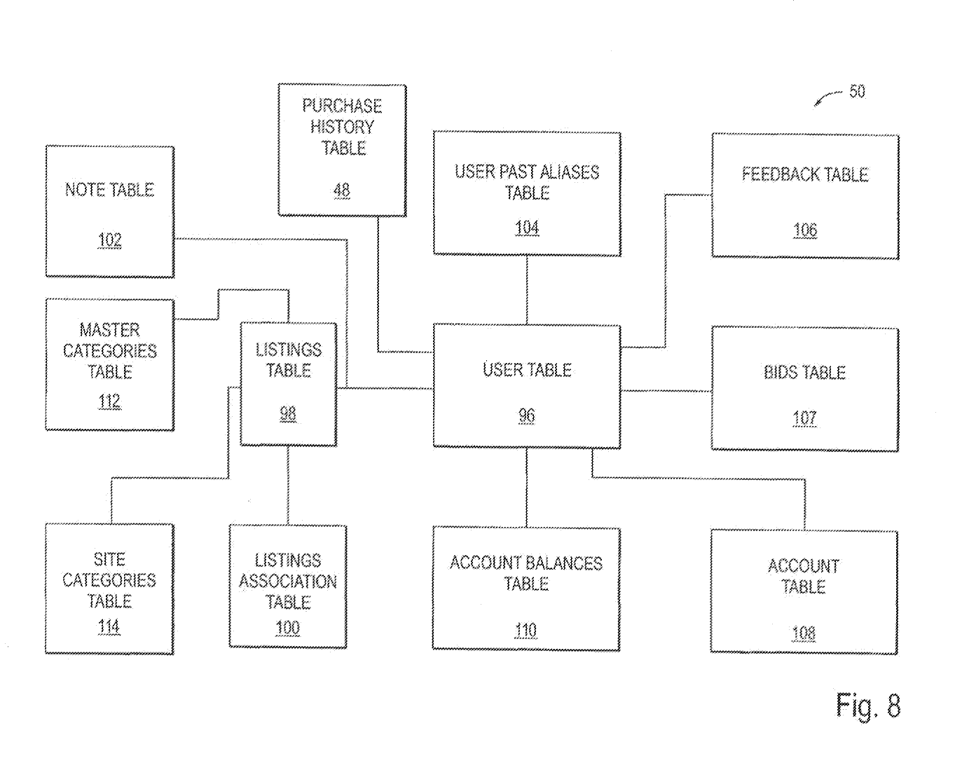

FIG. 8 is a database diagram illustrating an exemplary database 50 maintained and accessed via a database engine server 48 that supports the network-based marketplace machine 14. The database 50 may, in one embodiment, be implemented as a relational database, and includes a number of tables having entries, or records, that are linked by indices and keys. in an alternative embodiment, the database 50 may be implemented as a collection of objects in an Object oriented database.

The database 50 includes a user table 96 that contains a record for each user of the network-based marketplace machine 14. The user may operate as a seller, buyer, or both, within the network-based marketplace machine 14. The database 50 also includes listings table 98 that may be linked to the user table 96 and a listing association table 100. A user record in the user table 96 may be linked to multiple items that are being, or have been, transacted via the network-based marketplace machine 14.

The database 50 also includes a note table 102 populated with note records that may be linked to one or more listing records within the listings table 98 and/or to one or more user records within the user table 96. Each note record within the note table 102 may include, inter alia, a comment, description, history or other information pertaining to an item being auctioned via the network-based marketplace machine 14, or to a user of the network-based marketplace machine 14.

The number of other tables are also shown to be linked to the user table 96, namely a user past aliases table 104, a feedback table 106, a bids table 107, an account table 108, an account balances table 110 and a purchase history table 111.

The masters categories table 112 stores records for listing categories presented across multiple views (or presentations) of list categories via regional or community sites presented by the network-based marketplace machine 14. A site categories table 114 stores records indicating which item categories are to be presented for respective regional or community sites (e.g., a country, region or city specific site) presented by the network-based marketplace machine 14.

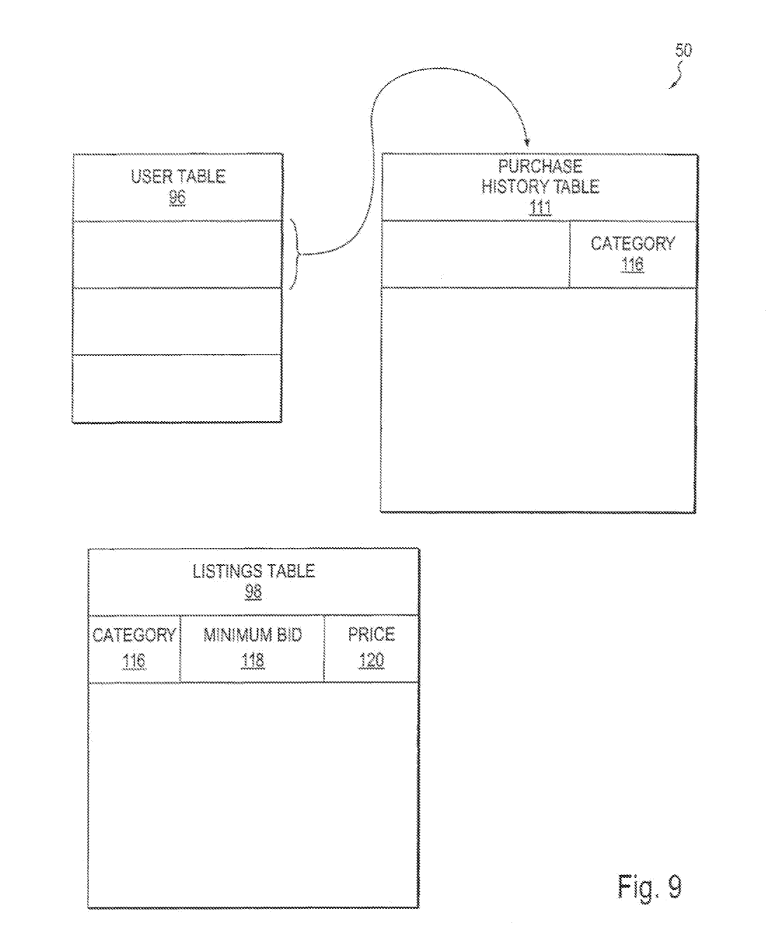

FIG. 9 is a database diagram illustrating selected fields from the user table 96, the purchase history table 111 and the listing table 98 as embodied on the database 50 at the network-based marketplace machine 14.

The user table 96 includes a link to the purchase history table 111. The purchase history table 111 includes records that chronicle the purchasing history of the associated user. Each record represents a purchase that is further described by a category 116 that is descriptive of the item or service purchased by the user.

The listings table 98 includes an entry for each listing presented on the network-based marketplace machine 14. A seller enters a listing to offer an item or service for auction or purchase on the network-based marketplace machine 14. Each listing may include, among other fields, the category 116, a minimum bid 118 that is initialized to enable an auction, and a price 120 that is initialized to enable a purchase.

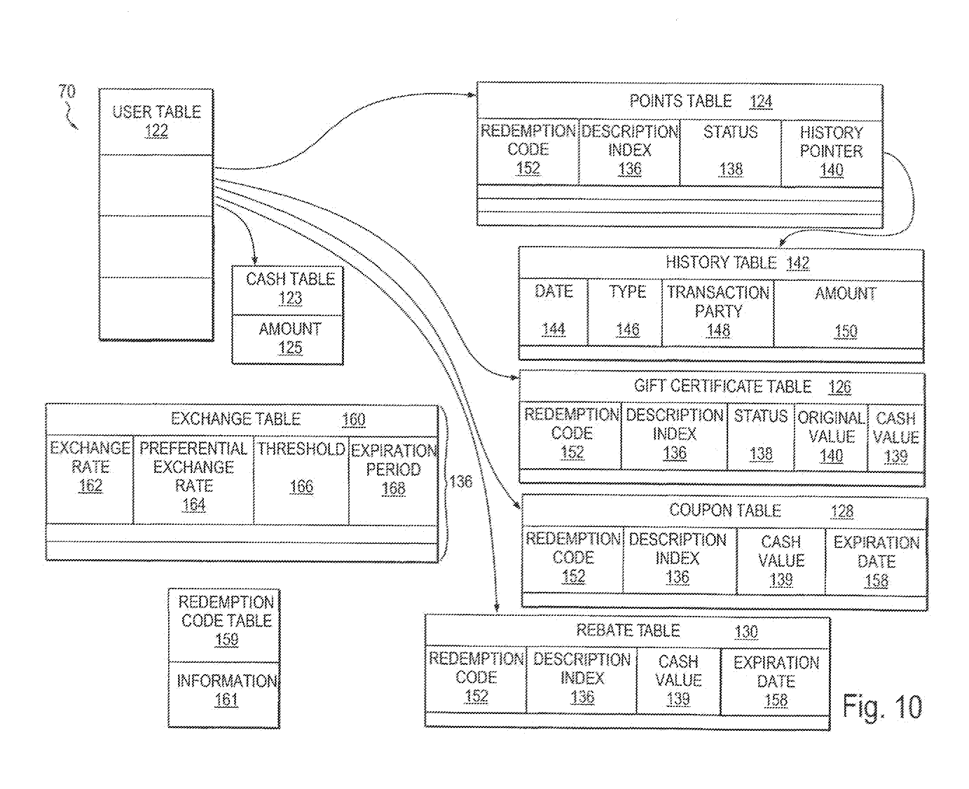

FIG. 10 is a database diagram illustrating an exemplary database 70 maintained and accessed via a database engine server 68 that supports the incentive engine 89 on the payment machine 16. The database may, in one embodiment, be implemented as a relational database, and includes a number of tables having entries or records, that are linked by indices and keys. In an alternative embodiment, the database 70 may be implemented as a collection of objects in an object-oriented database.

The database 50 includes a user table 122, which contains a record for each user of the payment machine 16. A user may operate as a payer or payee or both within the payment machine 16. Each user on the payment machine 16 is linked via the user table 122 to a points table 124, a gift certificate table 126, a coupon table 128, and a rebate table 130. Each of these tables identifies and describes a primary proprietary currency that may be converted to national currency.

The points table 124 includes an entry fir each type of points that are held. by the user where each entry represents a different account. Each account entry includes a redemption code 152, a description index 136, a status 138, and a history pointer 140. The redemption code may be entered by a user to uniquely identify the account.

The description index 136 identifies the type of points associated with the respective account. (e.g., XYZ Anything Points).

The status 138 may be active, restricted, locked or inactive, The active status indicating an account that is completely operable and the other statuses indicating varying levels of restricted operation

The history pointer 140 points to a history table 142. The history table 142 includes record of transactions associated with the account. Each record includes a date 144, a type 146, a transaction party 148, and an amount 150. The date 144 identifies the date of the transaction. The type 146 identifies the type of transaction and includes a credit, a debit or a correction. The transaction party 148 identifies the other party to the transaction. For example, ABC Honors might be the transaction party 148 that credits the account with XYZ Anything Points (e.g., the user converts ABC Honors Points to XYZ Anything Points). It will be appreciated that an account balance may be computed from the collection of records which comprise the transaction history.

The gift certificate table 126 includes an entry for each gift certificate held by the user where each entry represents a different account. Each account entry includes a redemption code 152, a description index 136, a status 138, an original value 154 and a cash value 139. The redemption code 152, the description index 136 and the status operate as previously described.

The original value 154 specifies the value of the gift certificate at issuance. The holder of the gift certificate may make purchases that utilize a proportion of the original value 154 leaving the cash value 139 to specify the current value of the gift certificate.

The coupon table 128 includes an entry for each coupon held by the user where each entry represents a different account. The coupon table 128 includes a redemption code 152, a description index 136, an expiration date 158 and a cash value 139. The redemption code 152, description index 136 and cash value 139 operate as described previously. The expiration date 158 identifies the date of the coupon expiration after which conversion to national currency is prohibited.

The rebate table 130 includes an entry for each rebate held by the user where each entry represents a different account. The rebate table 130 includes a redemption code 152, a description index 136, an expiration date 158 and a cash value 139. The redemption code 152, description index 136, cash value 139 and expiration date 158 operate as described previously.

The database 70 further includes an exchange table 160 where each entry describes exchange information with respect to the proprietary currency identified by the description index 136. Each entry includes an exchange rate 162, a preferential exchange rate 164, a threshold 166 and an expiration period 168.

The exchange rate 162 may be a multiplier that is multiplied by the associated proprietary currency identified by the description index 136 to arrive at a national currency. For example, the amount 150 (e.g., XYZ Anything Points) may be multiplied by the exchange rate 162 to produce a United States Dollars national currency cash value (e.g., 1 XYZ Anything Point=0.01 US Dollar=1 cent). As another example, the original value 154 associated with a gift certificate identified by the description index 136 may be multiplied by the exchange rate 162 to arrive at a US Dollar national currency amount. As a final example, a coupon or a rebate identified by the description index 136 may receive a value that is equivalent to the exchange rate 162 (e.g., the operation performed is determined via the description index 136).

The preferential exchange rate 164 identifies an exchange rate given to preferential users. The threshold 166 identifies a threshold of proprietary currency required to qualify for the preferential exchange rate 164. For example, a user with greater than 10,000 XYZ Anything Points may be qualified for a preferential exchange rate of 0.011 which represents a 10% bonus when converting from XYX Anything Points to USD.

The expiration period 168 may identify an expiration date for a proprietary currency. For example, points are credited via a transaction to a user account that occurs on a date 144. Points held beyond the expiration period will prohibit conversion to national currency.

The database 70 further includes a cash table 123 that specifies an amount 125 that is denominated in US Dollars and held by the owner of the account. The amount 125 is credited when the user receives payment in US Dollars and debited when the user makes a payment in US Dollars.

The database 70 further includes a redemption code table 159 that is used o authenticate a redemption code entered by the buyer and to identify a discrete unit of primary proprietary currency (e.g., a quantity of points, a coupon, etc). Associated with each redemption code is information 161 that includes the value, type, expiration date, description index, etc. of the identified primary proprietary currency and used to initialize the points table 124, the gift certificate table 126, the coupon table 128, etc.)

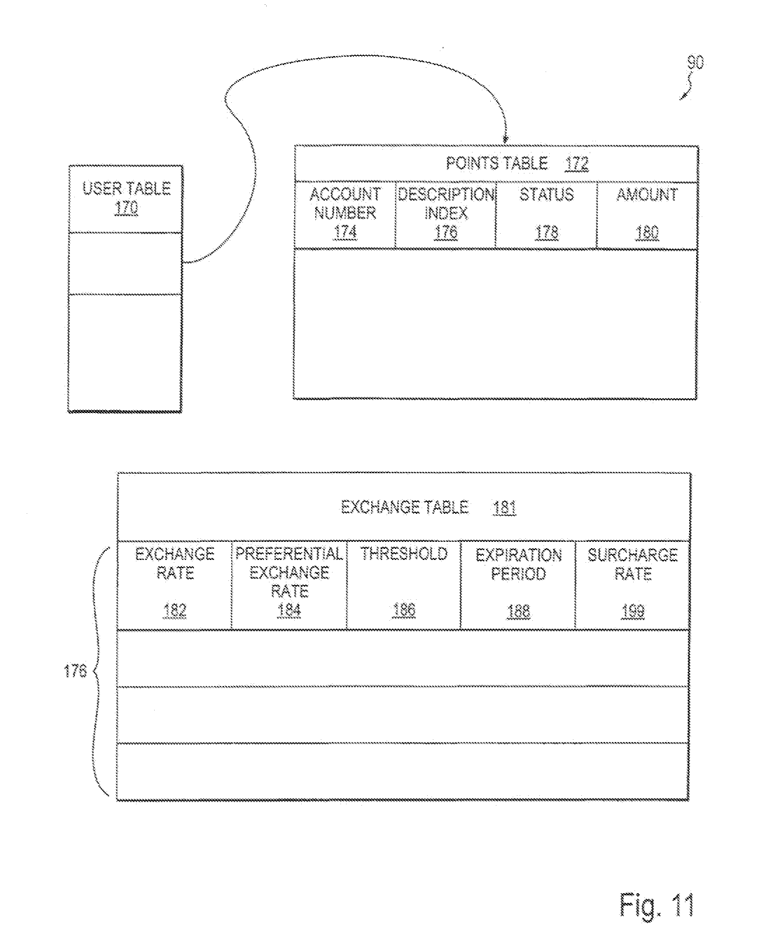

FIG. 11 is a database diagram illustrating an exemplary database 90 maintained and accessed via a database engine server 88 that supports the promotion machine 118. The database 90 may, in one embodiment, be implemented as a relational database and include a number of tables having entries or records, that are linked by indices and keys. In an alternative embodiment, the database 90 may be implemented as a collection of objects in an object oriented database.

The database 90 includes a user table 170, which contains a record for each user utilizing the services provided by the promotion machine 18. Each user record is linked to a points table 172. Each points table 172 includes information regarding a secondary proprietary currency (e.g., ABC Honors Points). A secondary proprietary currency is not readily convertible into a national currency but may be converted to a primary proprietary currency (e.g., XYZ Anything Points) that in turn may be converted to a national currency.

The points table 172 includes multiple entries where each entry represents an account associated with a type of points. Each entry includes an account number 174, a description index 176, a status 178 and an amount 180.

The account number uniquely identifies the account. The description index 176 identifies the type of points. The status 178 may be active, restricted, locked or inactive. The active status indicating an account that is completely operable and the other statuses indicating varying levels of restricted operation. The amount 180 specifies the amount of points.

The database 90 further includes an exchange table 181 where each entry describes exchange information with respect to the proprietary currency identified by the description index 136. Each entry includes an exchange rate 182, a preferential exchange rate 184, a threshold 186, an expiration period 188 and a surcharge rate 199.

The exchange rate 182 may be a multiplier that is multiplied by the associated second proprietary currency identified by the description index 136 to arrive at a first proprietary currency. For example, the amount 180 (e.g., ABC Honors Points) may be multiplied by the exchange rate 182 to produce an XYZ Anything Points amount. For example, 10,000 ABC Honors Points may be multiplied by the 10% exchange rate 182 to yield 1,000 ABC Anything Points. The exchange rate 182 is dynamic and may float up or down based on market conditions.

The preferential exchange rate 184 identifies an exchange rate given to preferential users. The threshold 186 identifies a threshold of secondary proprietary currency required to qualify for the preferential exchange rate 184. For example, a user with greater than 10,000 ABC Honors Points may be qualified for a 11% preferential exchange rate which represents a 10% bonus when converting from ABC Honors Points to XYX Anything Points.

The expiration period 188 may identify an expiration date for a proprietary currency. For example, points held beyond the expiration period 188 may expire and thereby prohibit conversion to primary proprietary currency.

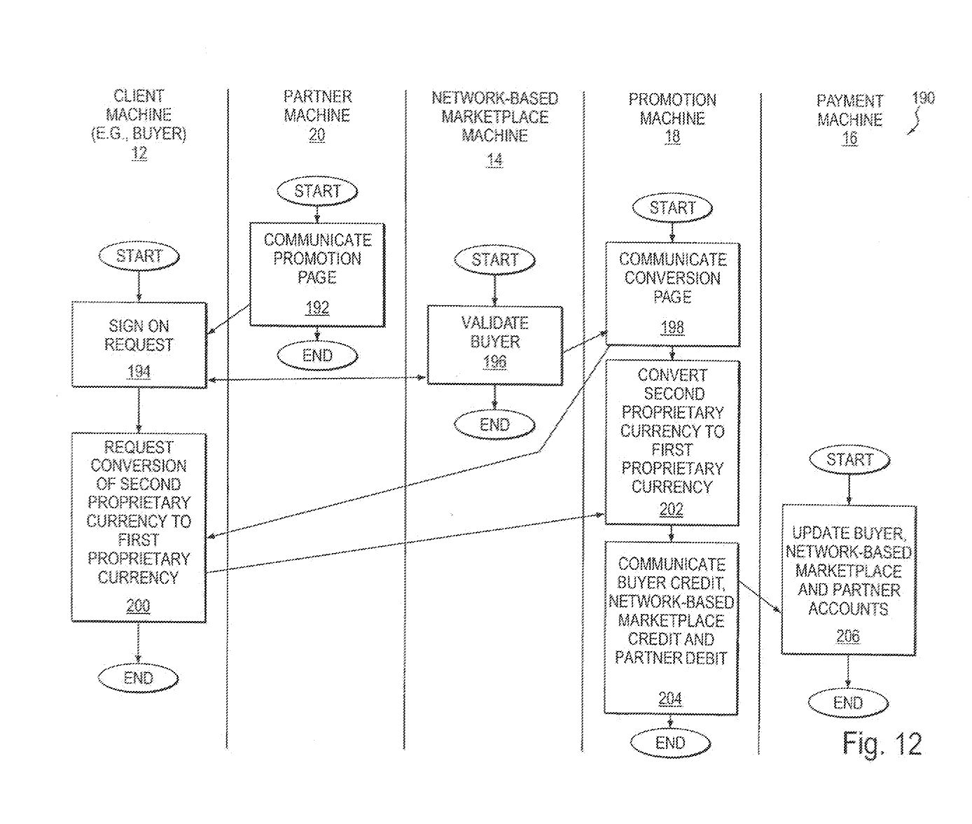

FIG. 12 is an interactive flow chart illustrating a method 190, according to an exemplary embodiment of the present invention, to convert at least one second proprietary currency to a first proprietary currency. Client and server operations are illustrated.

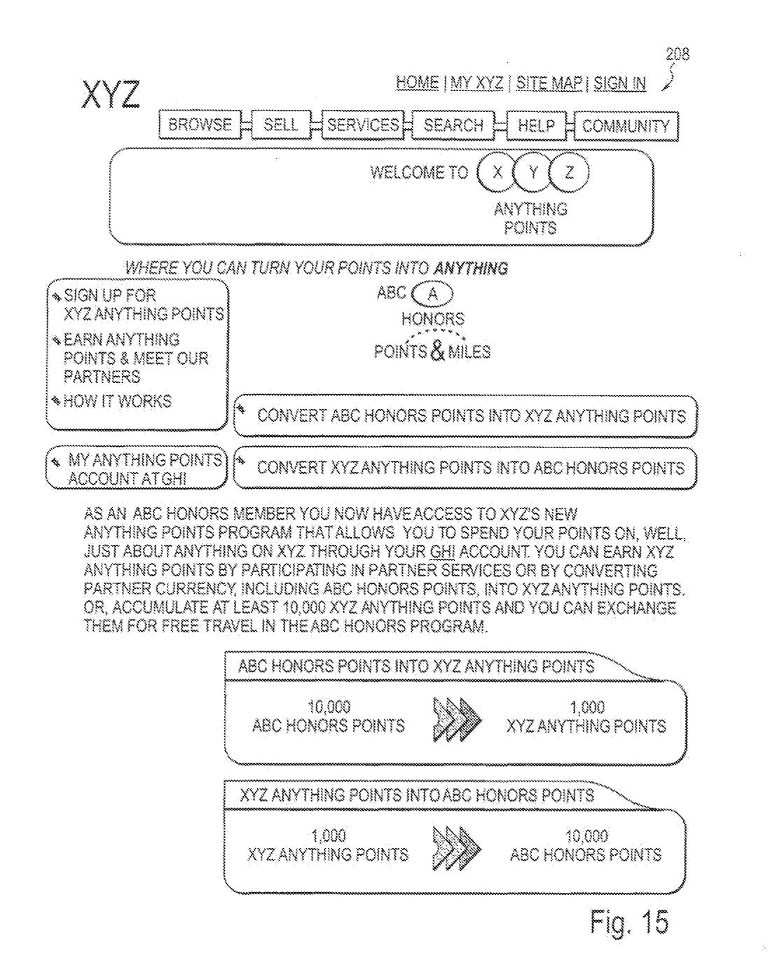

At box 192, a partner machine 20 communicates a promotion page 208 to a buyer at the client machine 12. FIG. 15 illustrates the promotions page 208 as viewed by the buyer at the client machine 12. The promotions page 208 includes a text 210 indicating that the buyer may request the conversion of ABC Honors Points into XYZ Anything Points.

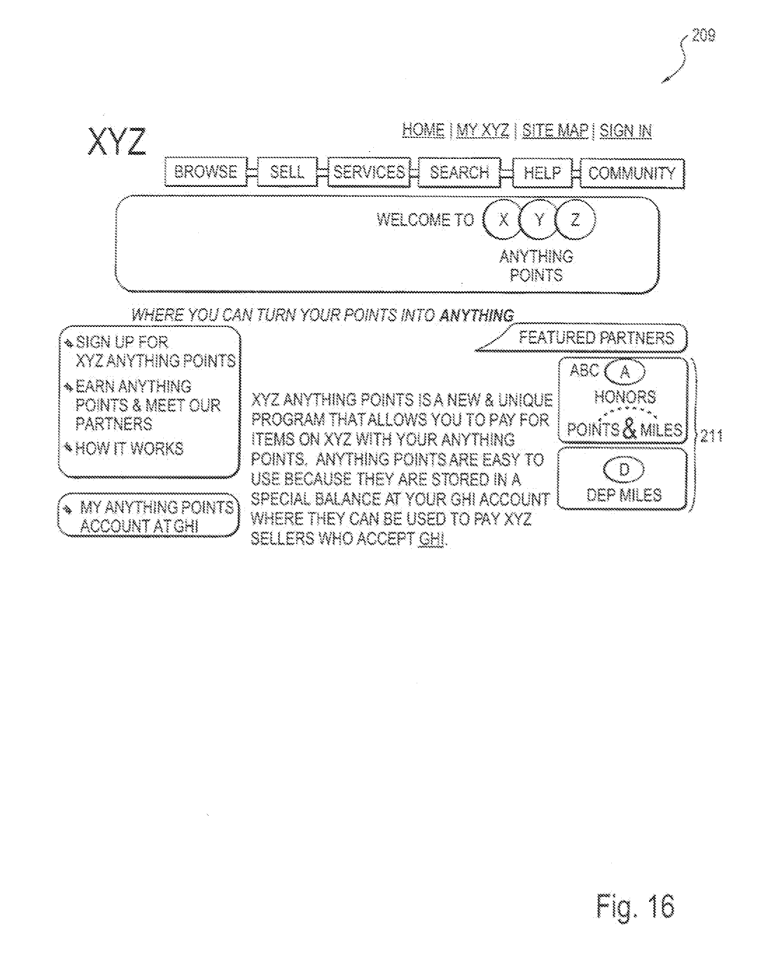

In another embodiment a network-based marketplace machine 14 communicates a promotion page 209 to the buyer at the client machine 12. FIG. 16 illustrates the promotions page 209 as viewed by the buyer at the client machine 12. The promotions page 209 includes a text 211 enabling the buyer to select from a number of partners. Once the buyer selects a partner, the appropriate and previously described promotion page 208 is communicated to the buyer and processing continues.

At box 194, the client machine 12 communicates the request to convert ABC Honors Points to the network-based marketplace machine 14 in response to the buyer selecting the text 210.

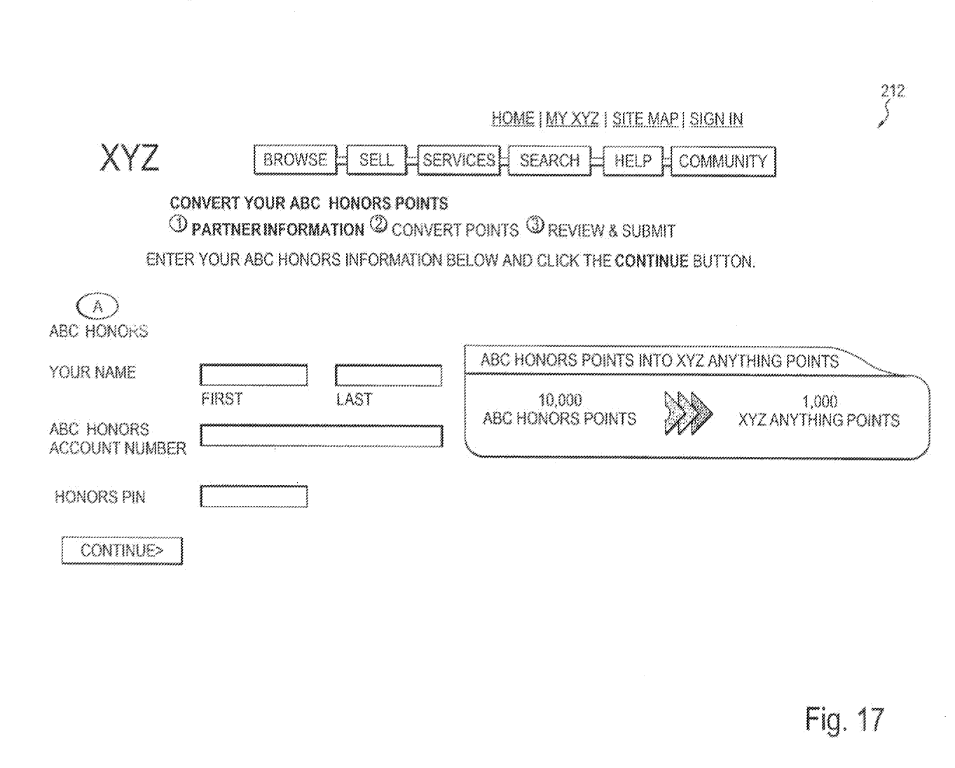

At box 196 the network-based marketplace machine 14 receives the request and responds by communicating a validation web page 212 to the buyer at the client machine 12. FIG. 17 illustrates an exemplary validation web page requesting that the buyer enter their name, account number and pin. After receiving the completed validation web page 212 from the buyer and validating the name, account number and PIN entered by the buyer, the network-based marketplace machine 14 communicates the request to convert ABC Honors Points to XYZ Anything Points to the promotion machine 18.

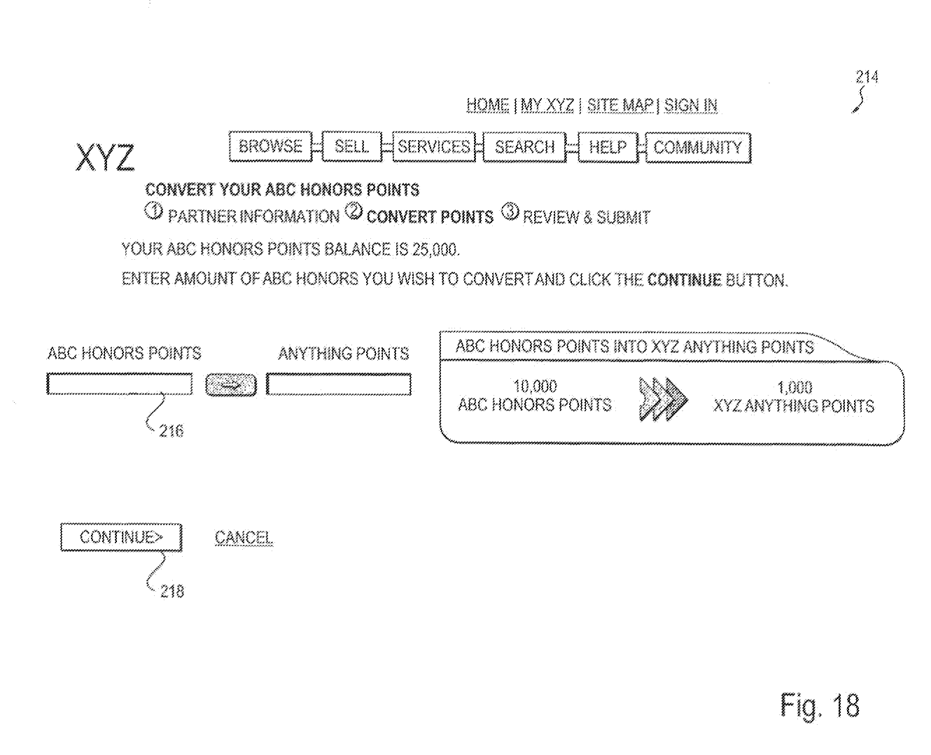

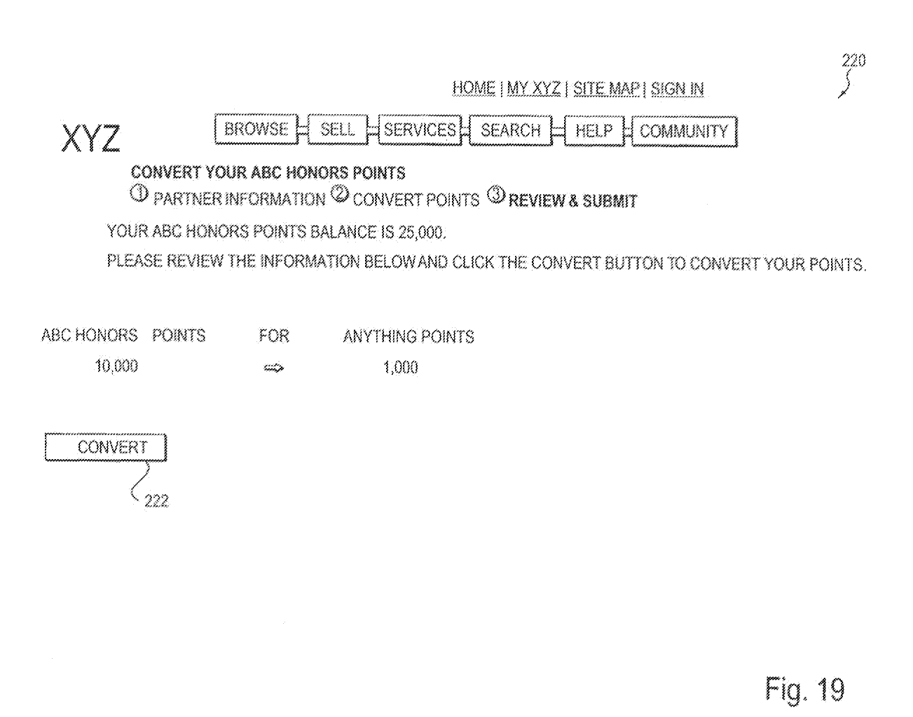

At box 198, the promotion machine 18 communicates an exemplary conversion web page 214 to the buyer at the client machine 12. FIG. 18 illustrates the conversion web page 214 that includes a window 216 where the buyer may enter the quantity of ABC Honors points for conversion to XYZ Anything Points. The buyer enters a quantity of ABC Honors Points and selects a continue button 218. The promotion machine 18 receives the quantity entered by the seller and responds with an exemplary review and submit web page 220, as illustrated in FIG. 19.

At box 200, at the client machine 12, the buyer selects a convert button 222 on the review and submit web page 220 to communicate a request to convert the 10,000 ABC Honors points into 1,000 XYZ Anything Points.

At box 202 the secondary conversion module 86 on the ISAPI/CTI server 84 at the promotion machine 18 receives the request to convert the ABC Honors Points to XYZ Anything Points. The secondary conversion module 86 utilizes the amount 180 in the points table 172 associated with the buyer to ensure the buyer holds an adequate number of ABC Honors Points. The secondary conversion module 86 further tests the status 178 associated with account and upon determining a valid request extracts the description index 176 from the points table 172 to index into the exchange table 181 and extract the appropriate exchange rate 182. The secondary conversion module 86 multiplies the exchange rate 182 by the amount of ABC Honors Points specified by the buyer for conversion to XYZ Anything Points. After computing the appropriate quantity of XYZ Anything Points, the secondary conversion module 86 subtracts the requested quantity of ABC Honors Points from the amount 180 and communicates the computed XYZ Anything Points to the payment machine 16.

In addition the secondary conversion module 86 computes an amount owed. to the network-based marketplace machine 14 based on the quantity of computed XYZ Anything Points. The secondary conversion module 86 computes the amount owed to the XYZ network-based marketplace machine 14 by multiplying the number of XYZ Anything Points by one cent (e.g., a pegged rate) and adding a surcharge. The surcharge is computed by multiplying the surcharge rate 199 by the number of XYZ Anything Points issued to the buyer. For example, issuance of 1,000 XYZ Anything Points and a surcharge rate of 0.0001 USD/XYZ Anything Points would result in crediting the network-based marketplace account with the amount of $10.10 USD ((1,000 XYZ Anything Points*0.01 USD/XYZ Anything Point)+(1,000 XYZ Anything Points 0.0001 USD/XYX Anything Point)) and debiting the partner account (i.e., the party that issued the ABC Honors points) for the same amount.

An alternate embodiment may include pegging the value of a single XYZ Anything Point to other quantities of US Dollars or to other national currencies.

At box 204, the secondary conversion module 86 communicates the XYZ Anything Points and the amount owed to the network-based marketplace to the payment machine 16.

At box 206, on the payment machine 16, 1,000 XYZ Anything Points are credited to the amount 150 in the points table 124 that is associated with an account of the buyer, $10.10 USD is credited to the amount 125 in the cash table 123 that is associated with an account of the network-based marketplace and $10.10 USD is debited to the amount 125 in the cash table 123 that is associated with an account of the partner.

In another embodiment, the incentive engine 89 may execute under the ISAPI/CGI server 42 on the network-based marketplace machine 14.

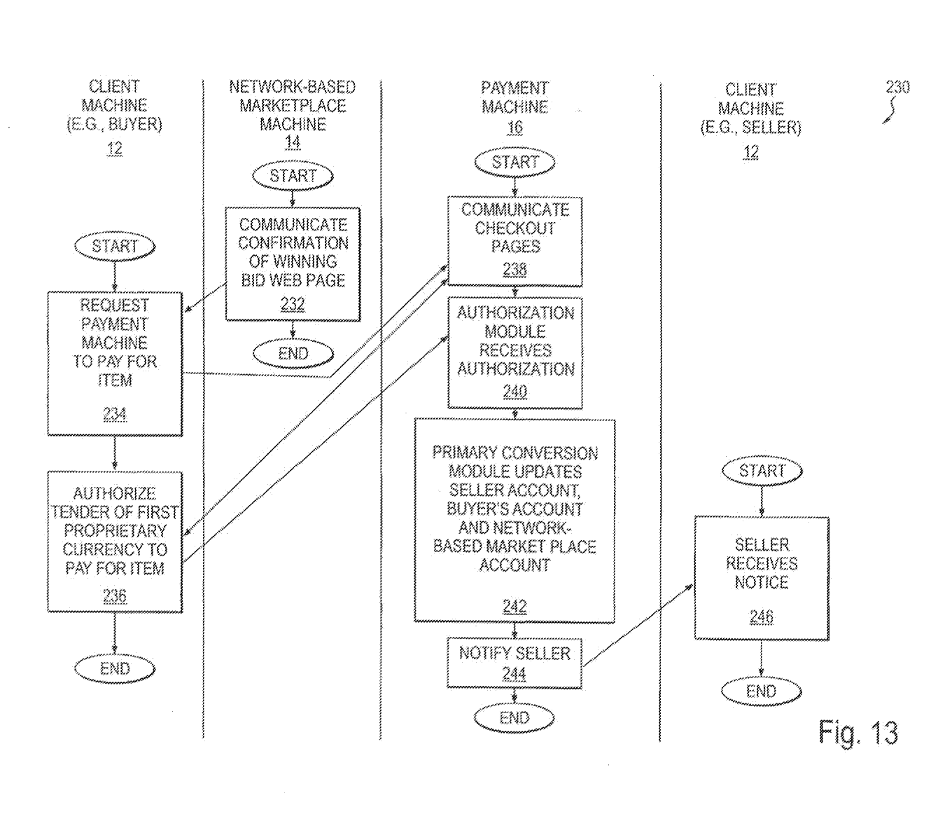

FIG. 13 is an interactive flowchart illustrating a method 230, according to an exemplary embodiment of the present invention, to discharge a liability owed to a buyer and stored to a primary proprietary currency. Client and server operations are illustrated.

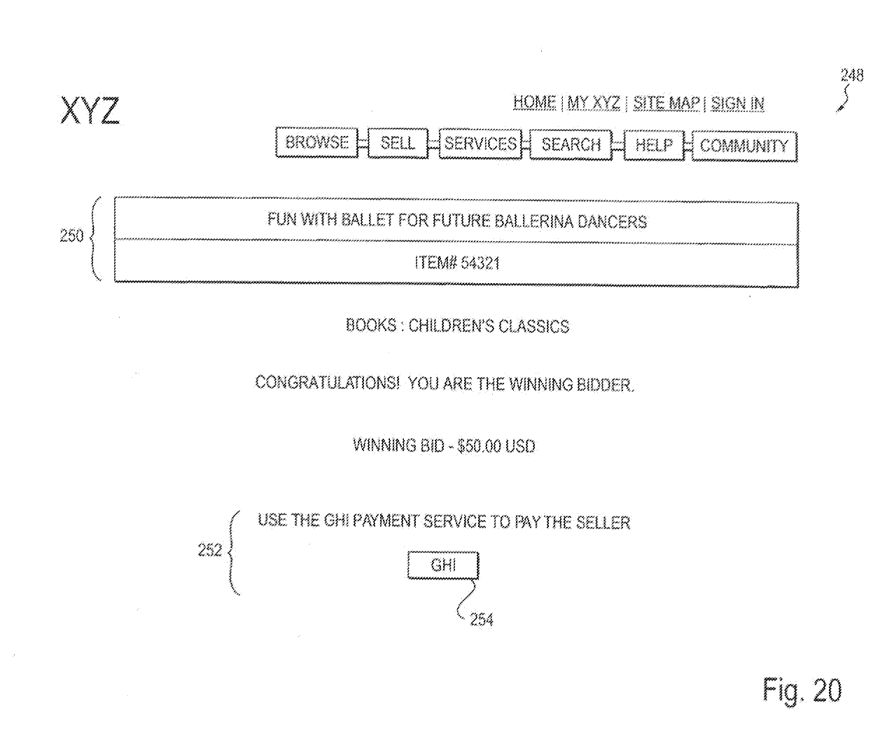

At box 232, the network-based marketplace machine 14 communicates a confirmation of winning bid web page 248 to the buyer at the client machine 12. FIG. 20 illustrates the confirmation of winning bid web page 248, according to an exemplary embodiment of the present invention. A text 250 indicates the buyer has submitted a winning bid for the item “54321” which is a book entitled, “Fun With Ballet for Future Ballerina Dancers.” The confirmation of winning bid web page 248 further includes a text 252 that encourages the buyer to use the GHI payment service to pay the seller.

Returning to FIG. 13, at box 234, the buyer, at the client machine 12, requests the services of the payment machine 16.

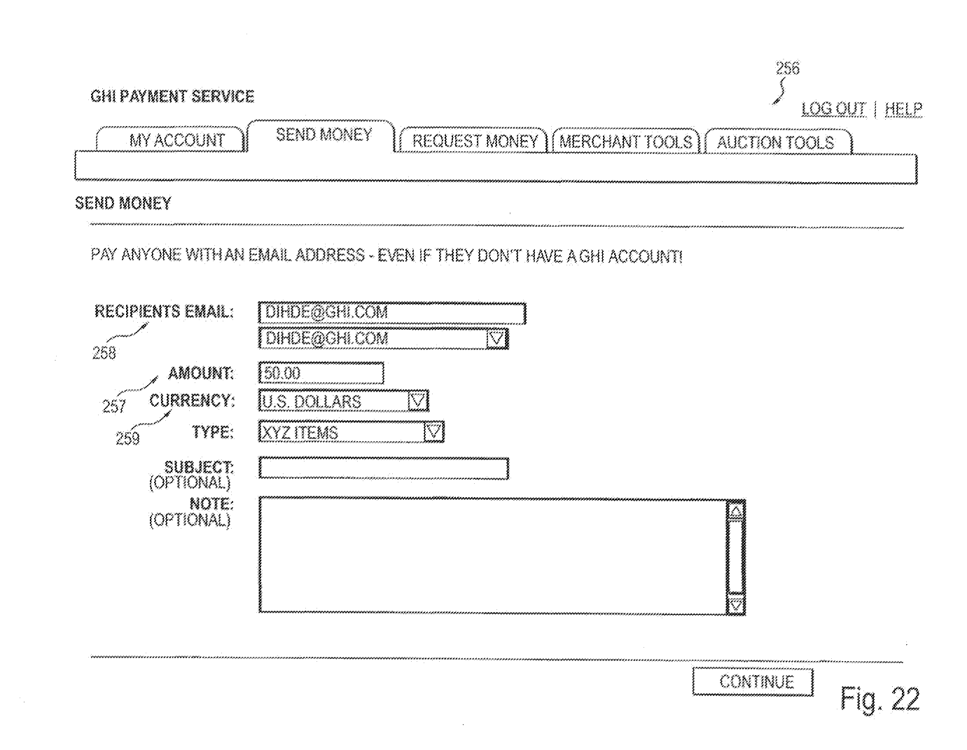

At box 238, the payment machine 16 receives the buyer's request and communicates checkout web pages to the buyer at the client machine 12. FIG. 22 illustrates a checkout web page 256, according to an exemplary embodiment of the present invention. The buyer enters the seller's or recipient's email address at a window 258 and further enters the amount to pay the seller at a window 257. The buyer may further request the type of national currency to pay the seller with a pull down window 259. For example, specifying payment in French Francs would result in the payment machine 16 performing an additional step that includes exchanging US Dollars for French Franks before paying the seller and, further, charging the buyer an exchange fee.

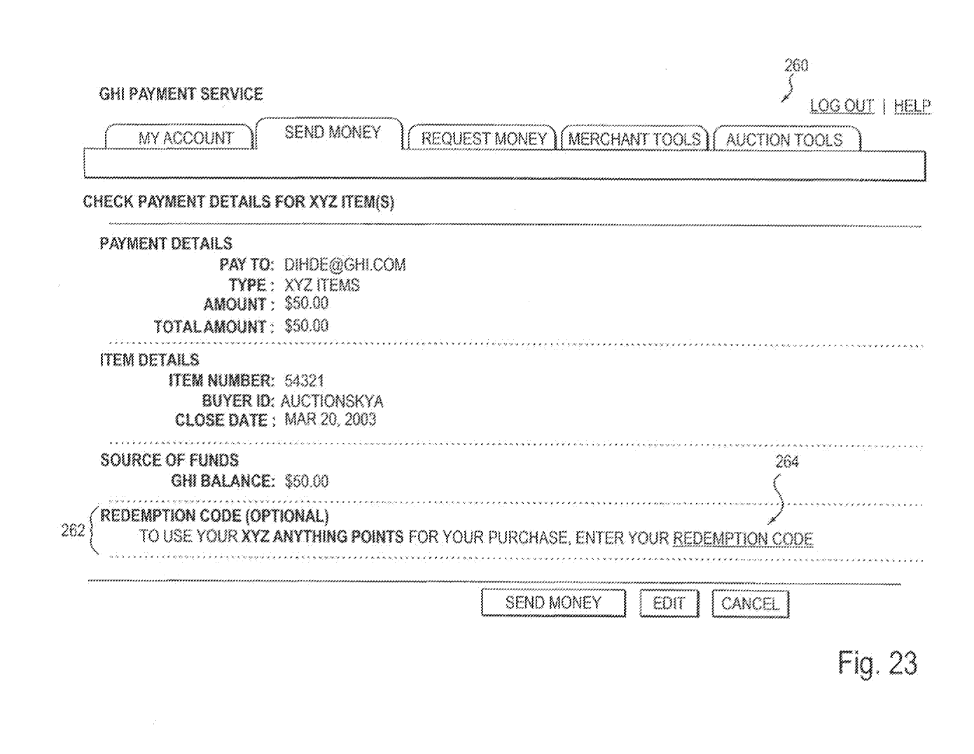

FIG. 23 illustrates a checkout web page 260, according to an exemplary embodiment of the present invention that summarizes payment details for the buyer. The checkout web page 260 includes a text 262 that communicates to the buyer that XYZ Anything Points may be used for the purchase. The buyer selects the text 264 and the payment machine communicates a checkout web page 266 to the buyer at the client machine 12.

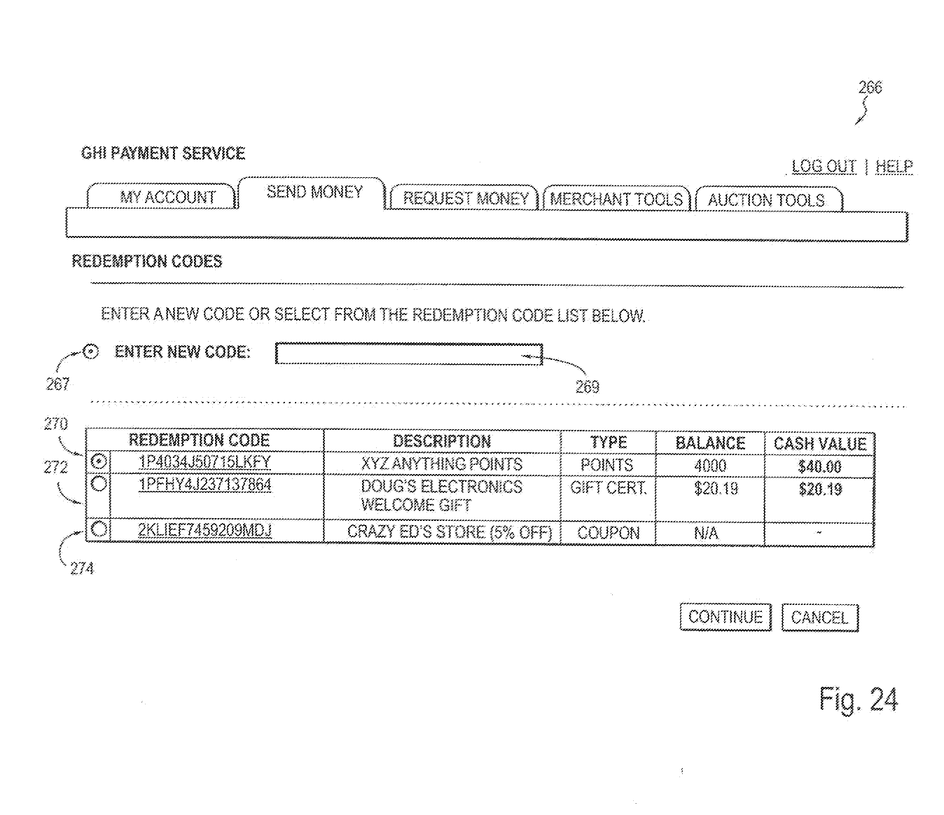

FIG. 24 illustrates the checkout web page 266, according to an exemplary embodiment of the present invention, to enable the buyer to select a proprietary currency to pay for the item or to enter a redemption code to identify a previously unidentified primary proprietary currency to the payment machine 16. The buyer may enter a redemption code 152 by selecting a radio button 267 and entering the redemption code 152 in a window 269. In addition, the buyer may select radio button 270 to make payment with the registered XYZ Anything Points or select radio button 272 or to make payment with registered “Doug's Electronics Welcome Gift” gift certificate or select radio button 274 to make payment with the registered “Crazy Ed's Store (5% off) Coupon. In each instance, a cash value associated with the points, gift certificate or coupon may be applied toward the purchase of the book. In the present example, the coupon could not be used to pay the seller because it does not have a cash value.

In response to the buyer entering the redemption code 152, the authorization module 91 utilizes the redemption code table 159 to authenticate a valid redemption code and initialize the appropriate table (e.g., the points table 124, the gift certificate table 126, the coupon table 128, etc.). The buyer selects the continue button and the payment machine communicates a checkout web page 268 to the buyer at the client machine 112.

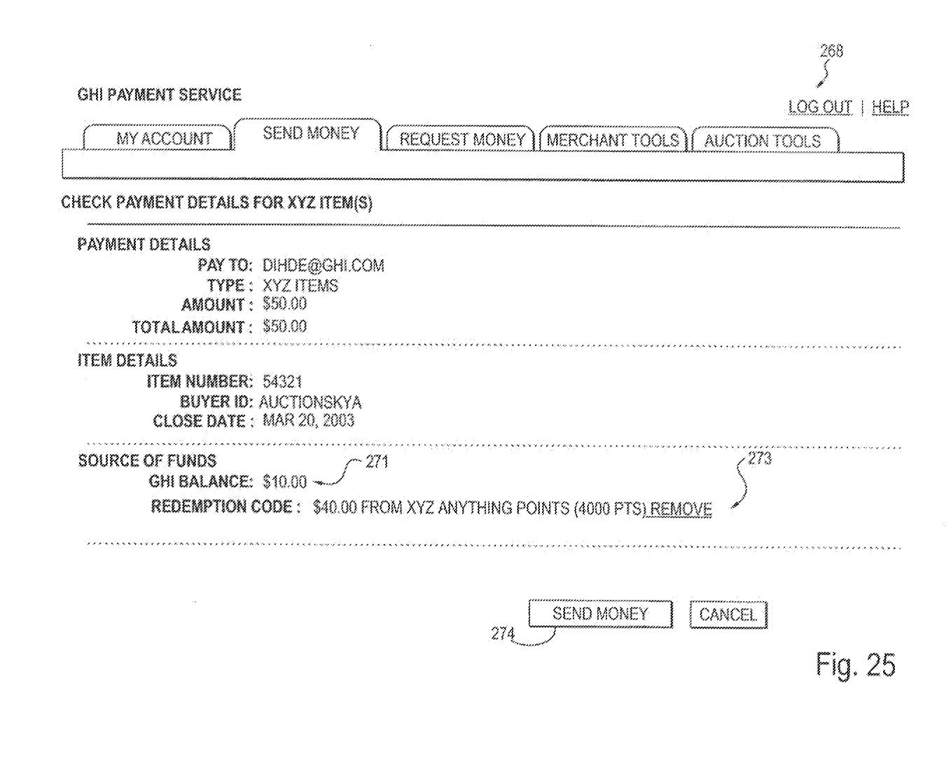

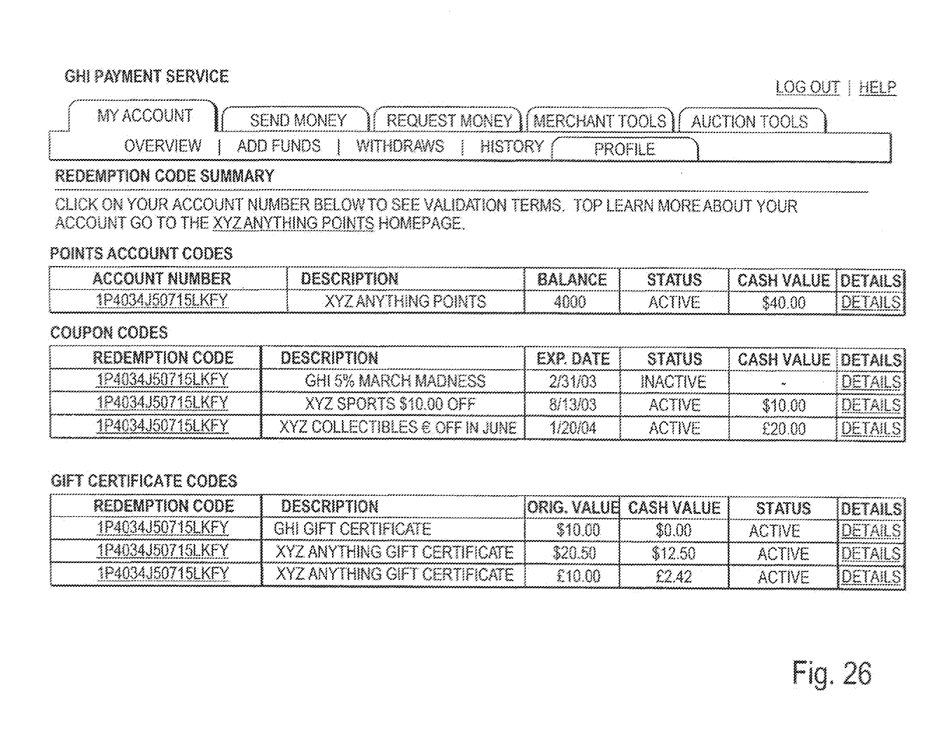

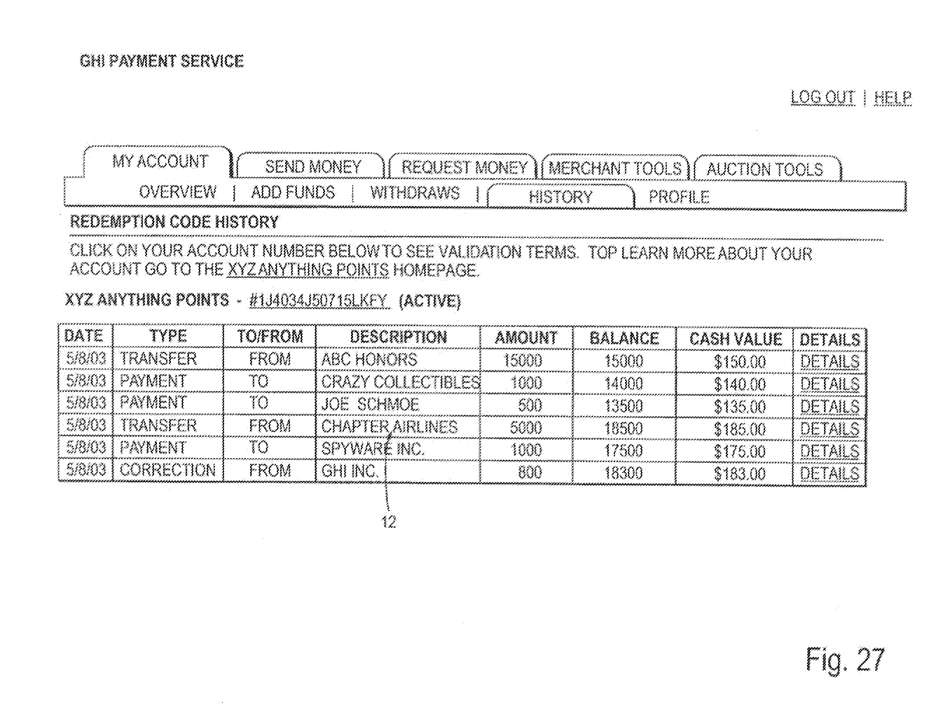

FIG. 25 illustrates the checkout web page 268, according to an exemplary embodiment of the present invention. The checkout web page 268 includes a text string 273 that indicates that the seller will be paid $40,00 USD after converting 4000 XYZ Anything Points into US currency. In addition, a text 271 indicates that the $10.00 balance due for the book will come from the buyer's account stored as the amount 125 in the cash table 123 associated with the buyer. In another embodiment, the buyer may pay for the balance of the book by debiting their credit card or bank account. Returning to FIG. 13, at box 236, the buyer at the client machine 12 authorizes tender of the primary proprietary currency by selecting a text 274 on the checkout web page 268.

At box 240, at the payment machine 16, an authorization module 91 receives the authorization from the buyer to tender the 4,000 XYZ Anything Points to pay for the “Fun With Ballet for Future Ballerina Dancers” book that was listed by the seller on the network-based marketplace machine 14. The authorization module 91 communicates the authorization to a primary conversion module 88 and ends.

At box 242, the primary conversion module 88 utilizes the user table 122 to access a points table 124 and a cash table 123 that are associated with the buyer. The primary conversion module 88 debits $10.00 USD from the cash table 123 by updating the amount 125. In addition, the primary conversion module 88 debits 4,000 XYZ Anything Points from the points table 124 by entering a record into the history table 142 associated with the points table 124. The record includes a debit for 4,000 XYZ Anything Points in an amount 150 field.

The primary conversion module 88 further utilizes the user table 122 to access a cash table 123 that is associated with the seller. The primary conversion module 88 credits $50.00 USD to the cash table 123 by updating the amount 125 in the cash table 123.

The primary conversion module 88 further utilizes a user table 122 to access a points table 124 and a cash table 123 that are associated with the network-based marketplace. The primary conversion module 88 debits $40.00 USD from the cash table 123 by updating the amount 125 in the cash table 123. In addition, the primary conversion module 88 credits 4,000 XYZ to the points table 124 by entering a record into the history table 142 associated with the points table 124. The record includes a 4,000 XYZ Anything Points credit in an amount 150 field.

At box 244, the payment machine 16 communicates an email to the seller providing notice that payment has been made for the “Fun With Ballet for Future Ballerina Dancers” book.

At box 246, at the client machine 12, the seller receives notice that payment has been made,

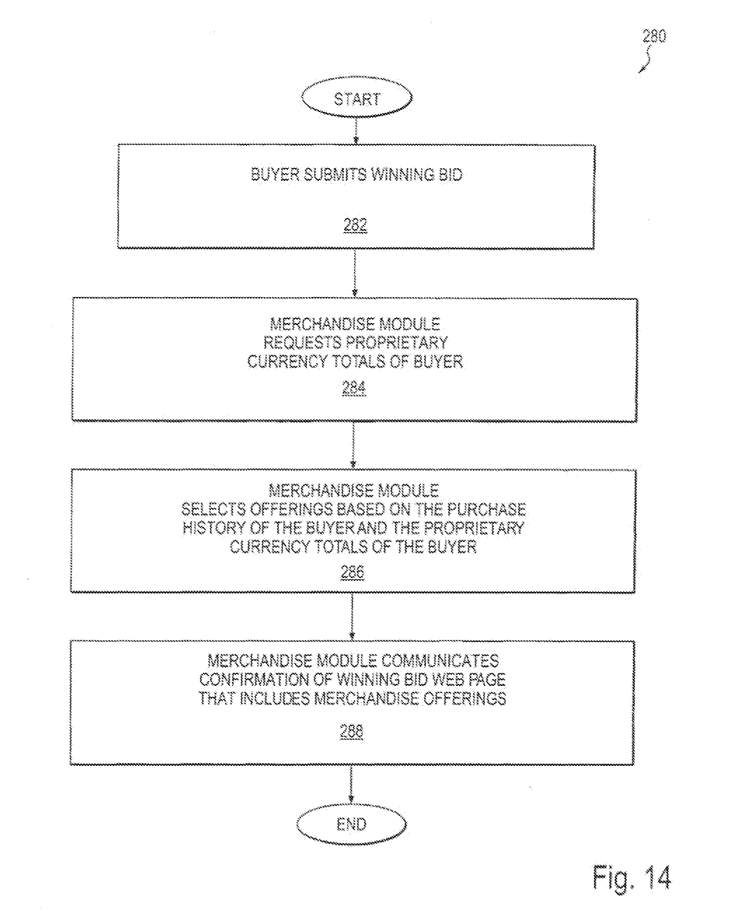

FIG. 14 is a flowchart illustrating a method 280, according to an exemplary embodiment of the present invention, to merchandise offerings to a buyer based on the quantity of primary proprietary currency owned by the buyer and the marketing history of the buyer. Client and server operations are illustrated.

At box 282, the buyer submits a winning bid to the network-based marketplace machine 14.

At box 284, the merchandising module 92 requests the buyer's proprietary currency totals from the payment machine 16 via ate application program interface.

At box 286, the merchandising module 92 selects offerings based on the purchasing history and proprietary currency totals associated with the buyer. For example, the merchandising module 92 might generate a list of categories by accessing the user table 96 and extracting categories of recent purchases made by the buyer from the purchase history table 111 associated with the buyer. The merchandising module 92 may utilize the list of the categories 116 to search the listing table 98 and for similarly categorized listings. For each similar listing the merchandising module 92 compares the price 120 or the minimum bid 118 to the current value of the total proprietary currency held by the buyer. For example, if the buyer has $40.00 USD worth of XYZ Anything Points then the merchandising module 92 may select a number of listings for less than or equivalent to $40.00 USD that additionally share at least one category identified via the purchases history table 111.

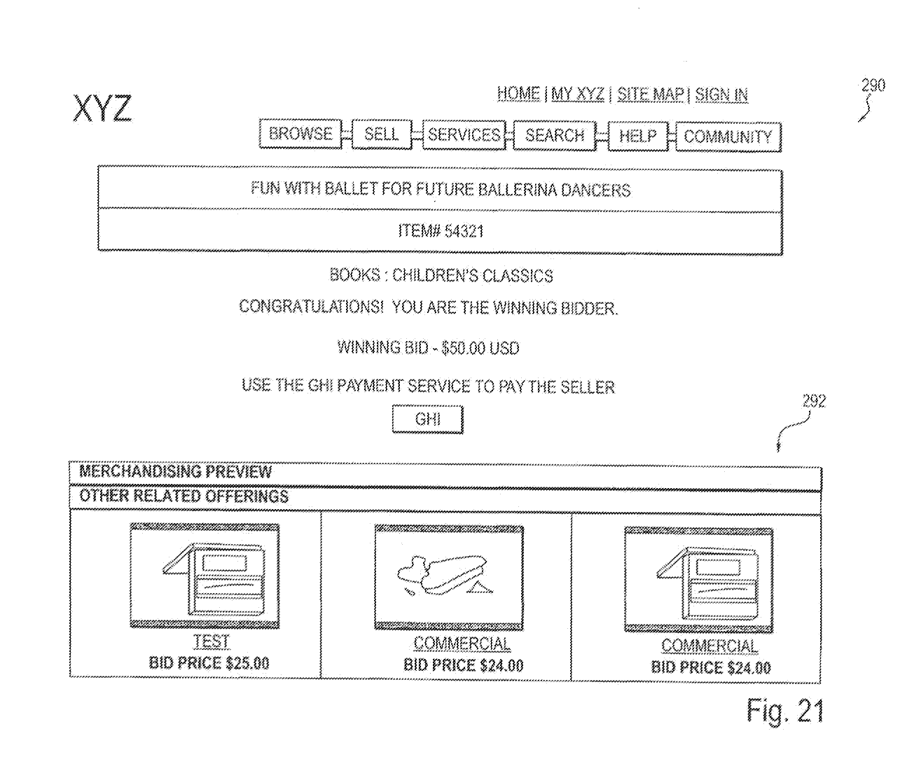

At box 288, the merchandise module 92 communicates a confirmation of winning bid web page 290 to the buyer at the client machine 12 that includes the previously selected listings. FIG. 21 illustrates the confirmation of winning bid web page 290, according to an exemplary embodiment of the present invention. The confirmation of winning bid web page 290 includes a merchandising preview panel 292, which includes three listings that have been selected based on the purchasing history and proprietary currency totals associated with the buyer.

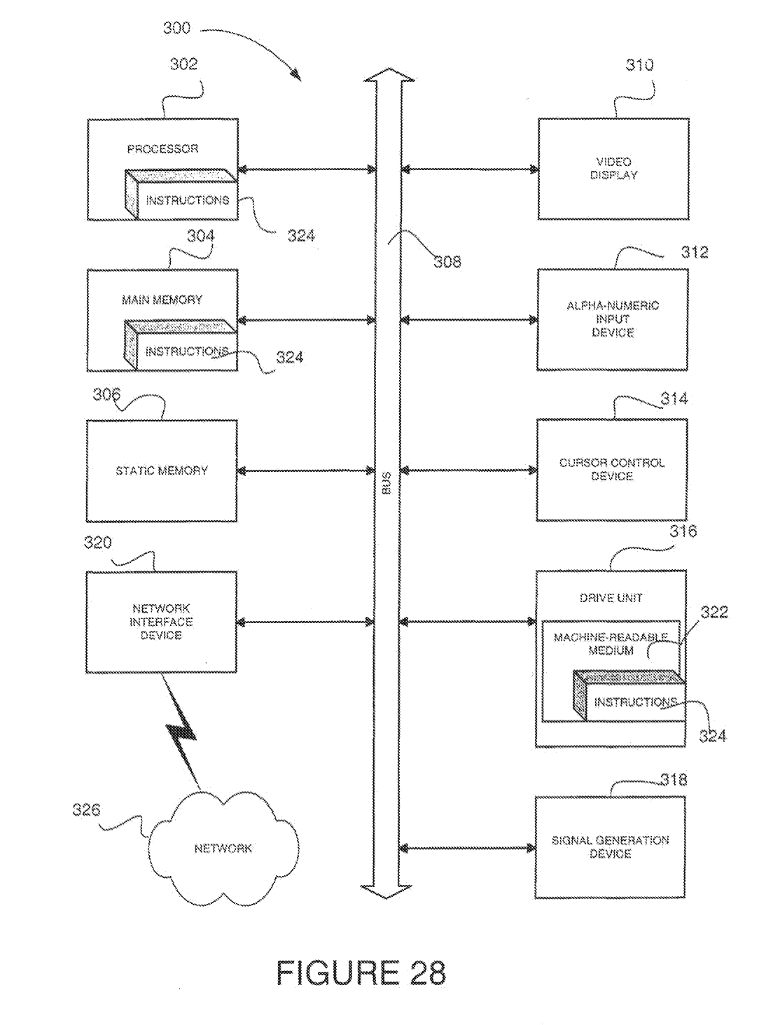

FIG. 28 illustrates a diagrammatic representation of machine in the exemplary form of a computer system 300 within which a set of instructions, for causing the machine to perform any one or more of the methodologies discussed herein, may be executed. In alternative embodiments, the machine operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU) a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alpha-numeric input device 312 (e.g., a keyboard), a cursor control device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320.

While the machine-readable medium 322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to included, but not be limited to, solid-state memories, optical and magnetic media, and carrier wave signals.

Thus, method and system to discharge a liability associated with a proprietary currency, have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A computer implemented method to discharge a liability owed to a seller and stored in a first proprietary currency, the method including:
maintaining a database of a plurality of exchange rates for converting the first proprietary currency to a national currency;
receiving authorization from the buyer to tender an amount of the first proprietary currency to pay for an offering that is listed by a seller on a network-based marketplace, the first proprietary currency being issued by the network-based marketplace;
debiting, using at least one processor, the amount of the first proprietary currency from a table associated with the first proprietary currency for the buyer;
determining an exchange rate from the plurality of exchange rates to use in converting the first proprietary currency to the national currency;
converting the amount of the first proprietary currency into an amount of national currency using the determined exchange rate; and
transmitting the amount of national currency to the seller, the seller receiving the national currency as payment for the offering, the transmission to at least partially discharge the liability owed to the seller.

2. The computer implemented method of claim I, wherein maintaining the database further includes storing at least one preferential exchange rate in the plurality of exchange rates and storing a threshold associated with the preferential exchange rate.

3. The computer implemented method of claim 2, wherein determining the exchange rate from the plurality of exchange rates includes:
selecting the preferential exchange rate when a total of the buyer's first proprietary currency is above the threshold.

4. The computer implemented method of claim 1, wherein the first proprietary currency includes the at least one of a coupon, a rebate, a gift certificate and at least one point.

5. The computer implemented method of claim 1, including converting at least one second proprietary currency to the first proprietary currency.

6. The computer implemented method of claim 1, wherein e first proprietary currency expires after a predetermined period of time.

7. The computer implemented method of claim 1, including merchandising a second offering to the buyer based on a quantity of the first proprietary currency owned by the buyer.

8. A non-transitory computer readable medium with instructions stored thereon, which when executed by at least one processor, cause the at least one processor to perform operations to discharge a liability owed to a seller and stored in a first proprietary currency, the method including, the operations comprising:
receiving authorization from the buyer to tender an amount of the first proprietary currency to pay for an offering that is listed by a seller on a network-based marketplace, the first proprietary currency being issued by the network-based marketplace;
debiting, using at least one processor, the amount of the first proprietary currency from a table associated with the first proprietary currency for the buyer;
determining an exchange rate from the plurality of exchange rates to use in converting the first proprietary currency to the national currency;
converting the amount of the first proprietary currency into an amount of national currency using the determined exchange rate; and
transmitting the amount of national currency to the seller, the seller receiving the national currency as payment for the offering, the transmission to at least partially discharge the liability owed to the seller.

9. The non-transitory computer readable of claim 8, wherein maintaining the database further includes storing at least one preferential exchange rate in the plurality of exchange rates and storing a threshold associated with the preferential exchange rate.

10. The non-transitory computer readable of claim 9, wherein determining the exchange rate from the plurality of exchange rates includes:
selecting the preferential exchange rate when a total of the buyer's owned first proprietary currency is above the threshold.

11. The non-transitory computer readable medium of claim 8, wherein the first proprietary currency includes the at least one of a coupon, a rebate, a gift certificate and at least one point.

12. The non-transitory computer readable medium of claim 8, wherein the operations include converting at least one second proprietary currency to the first proprietary currency.

13. The non-transitory computer readable medium of claim 8, wherein he first proprietary currency expires after a predetermined period of time.

14. The non-transitory computer readable medium of claim 8, wherein the operations include merchandising a second offering to the buyer based on a quantity of the first proprietary currency owned by the buyer.

15. A system to discharge a liability owed to a seller and stored in a first proprietary currency, the system including:
a database storing a plurality of exchange rates for converting the first proprietary currency to a national currency;
one or more processors;
a computer-readable storage medium with instructions stored thereon, the one or more processors interacting with the computer-readable storage medium to execute operations on components comprising:
an authorization module configured to receive authorization from the buyer to tender an amount of the first proprietary currency to pay for an offering that is listed by a seller on a network-based marketplace, the first proprietary currency being issued by the network-based marketplace; and
a primary conversion configured module to:
determine an exchange rate from the plurality of exchange rates to use in converting the first proprietary currency to the national currency;
convert the amount of the first proprietary currency into an amount of national currency using the determined exchange rate; and
transmit the amount of national currency to the seller, the seller receiving the amount of national currency as payment for the offering, the transmission to at least partially discharge the liability owed to the seller.

16. The system of claim 15, wherein the database stores at least one preferential exchange rate in the plurality of exchange rates and storing a threshold associated with the preferential exchange rate.

17. The system of claim 16, wherein determining the exchange rate from the plurality of exchange rates includes selecting the preferential exchange rate when a total of the buyer's owned first proprietary currency is above the threshold.

18. The system of claim 15, wherein the first proprietary currency includes at least one of a coupon, a rebate, a gift certificate and at least one of point.

19. The system of claim 15, further comprising a secondary conversion module configured to convert an amount of first proprietary currency into at least one second proprietary currency.

20. The system of claim 15, wherein the authorization module is to cause the first proprietary currency to expire after a predetermined period of time.
